(19) United States
(12) Patent Application Publication
(10) Pub. No.: US 2009/0209888 A1
(43) Pub. Date: Aug. 20, 2009

(54) Spine Wheel

(76) Inventor: Seyed Hessam Khatami, Houston, TX (US)

Correspondence Address: MICHAEL COLE MACKEY, 1217 CROSBY STREET, HOUSTON, TX, 77019, US

(21) Appl. No.: 12/032,981

(22) Filed: Feb. 18, 2008

(51) Int. Cl. A61H 15/00

(52) U.S. Cl. 601/124; 601/119; 601/120

(57) ABSTRACT

A roller system for treating trigger points including an axle and at least one wheel coupled to the axle and wherein the at least one wheel may be coupled to the axle at any location along the length of the axle. A method of treating trigger points including providing a roller system and rolling at least one wheel across a desired location on a patient's body.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to the promotion of healing in muscles; and more specifically relate to treating hyperirritable muscle areas.

2. Description of the Related Art

Hyperirritable areas in muscles can be sources of extreme pain and discomfort. Muscle discomfort can occur anywhere in the body and may manifest through symptoms such as tight or sore muscles and related pain. Common areas in which such symptoms occur include the neck, shoulders and back. A common treatment of muscle pain is ischemic compression, or the application of continuous pressure. Such a treatment can assist in restoring circulation and reducing muscular tension, thus promoting the healing of tense muscle areas. Anyone, including doctors, massage therapists, or patients may employ various techniques for treatment of muscles.

The inventions disclosed and taught herein are directed to an improved system and method for the treatment of muscles.

### BRIEF SUMMARY OF THE INVENTION

A roller system for treating trigger points, including an axle having a first end and a second end, a first handle coupled to the first end of the axle, and a second handle coupled to the second end of the axle. The roller system may have one or more wheels rotatably coupled to the axle between the first and second ends, each of which may be coupled at any location along the length of the axle between the first and second handles.

A method of treating trigger points, including providing a patient having one or more trigger points, providing a roller system having an axle and at least one wheel rotatably coupled along the axle, and rolling the at least one wheel across a desired location on the patient's body such that the wheel manipulates one or more of the trigger points.

### BRIEF DESCRIPTION OF THE SEVERAL VIEWS OF THE DRAWINGS

FIG. 1 illustrates a roller system having two wheels.

FIG. 2 illustrates a roller system having one wheel.

FIG. 3 illustrates a roller system having a mounting bracket.

FIG. 4 illustrates a non-smooth wheel in accordance with the present invention.

FIG. 5 illustrates another non-smooth wheel in accordance with the present invention.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. The term “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, directly or indirectly with intermediate elements, one or more pieces of members together and can further include without limitation integrally forming one functional member with another in a unity fashion. The coupling can occur in any direction, including rotationally. The term “trigger point” and like terms are also used broadly herein and can include any muscle, including but not limited to soar, achy, hyperirritable, tight or perfectly healthy muscles.

Applicant has created a roller system for use in the treatment of muscles, such as soar, achy, or hyperirritable areas in muscles.

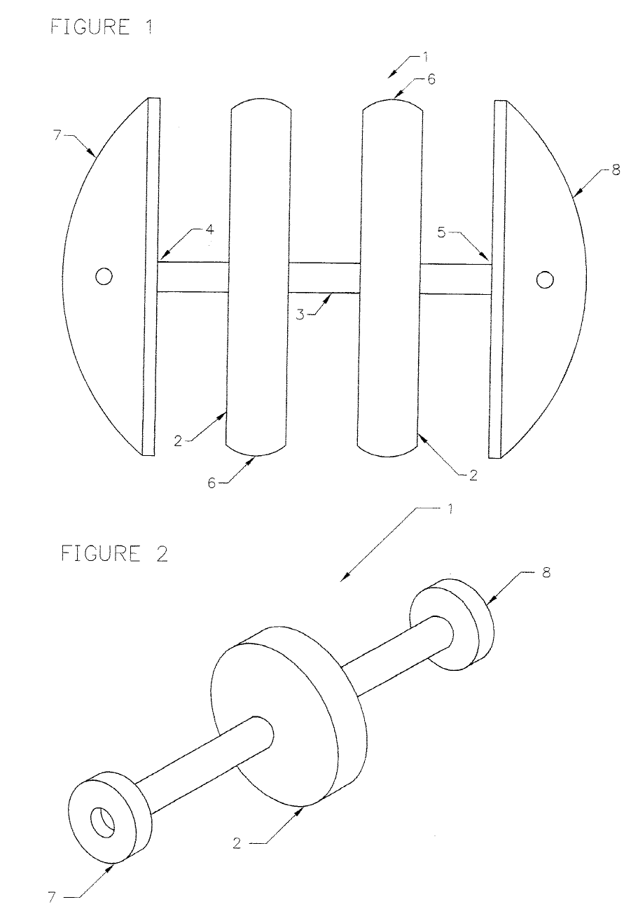

FIG. 1 illustrates a roller system 1 having two wheels 2. The two wheels 2 may be coupled to an axle 3 at any point between a first end 4 and a second end 5. The wheels 2 may be, for example, threaded onto the axle, fixed using a set screw, or positioned using other means. The wheels 2 may be made of rubber, plastic, or any material. Further, the treating surface 6 of the wheels 2 may be smooth, rough, or, as another example, contoured in accordance with a particular application. For example, the treating surface 6 may be adjusted for width, hardness and/or bumpiness to meet a particular patient's needs or desires. Such adjustments may be made, for example, by switching out the wheels 2, such as by removing smooth wheels and coupling other desired wheels to the axle 3.

Furthermore, a first handle 7 may be coupled to the first end 4 of the axle 3. Similarly, a second handle 8 may be coupled to the second end 5 of the axle 3. The handles 7, 8 may be used to grasp or hold, such as to enable a user to manipulate the system 1, for example, along a patient's spine or other desired area. The handles 7, 8 may be made of any material and may be any shape. Further, the handles may be larger or smaller than the diameter of the particular wheels 2 being used and may be grasped or supported in any manner.

FIG. 2 illustrates a roller system 1 having one wheel 2. The description above, where applicable, applies generally hereto. Furthermore, in some embodiments, such as the one shown in FIG. 2, the handles 7, 8 may, for example, be smaller in diameter than the wheel 2. Such an embodiment may be preferred, for example, where a user desires to concentrate the treatment on one area of the body, while avoiding surrounding areas.

A user may treat any desired area of the body using the roller system 1. For example, a user may roll one or more wheels 2 across any desired area of their or another's body, such as one's back, shoulders, or as another example, neck. In doing so, a user may apply any desired amount of force and may do so at any pace, continuously or otherwise.

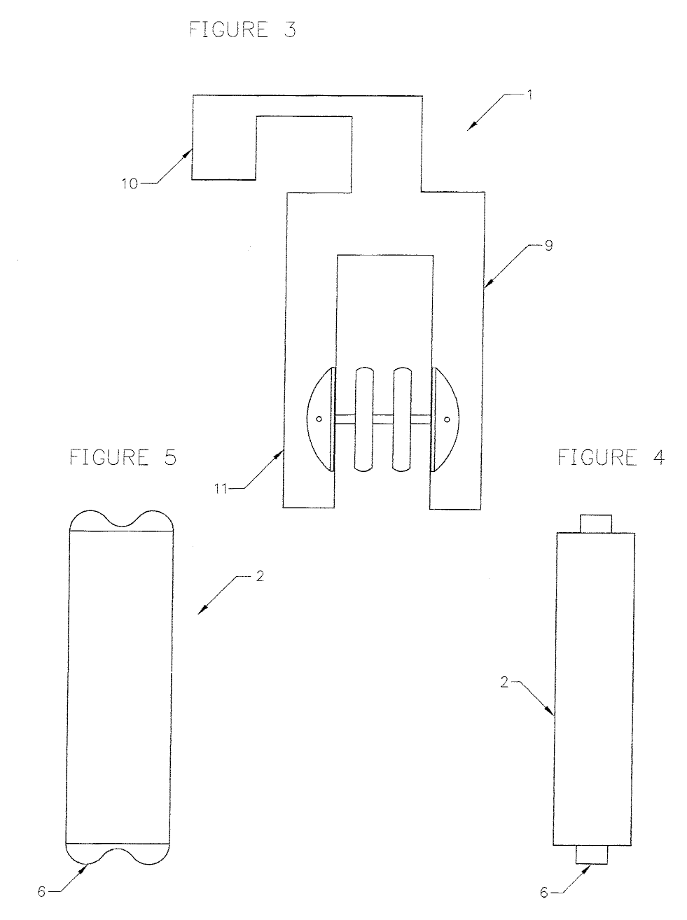

FIG. 3 illustrates a roller system 1 having a mounting bracket 9. A first end 10 of the bracket 9 may be coupled to any stationary object, such as for example a door, wall, or exercise machine. As shown in this exemplary embodiment, the handles 7, 8 of the system 1 may be coupled to an opposite end 11 of the bracket 9. Furthermore, the bracket 9 may be fixed or adjustable, such as to accommodate a particular user's height, and may enable a patient to use the roller system 1 to treat their own trigger points. The system 1 may be coupled to the bracket 9 in any manner, permanently, removably, or otherwise.

FIG. 4 illustrates a non-smooth wheel 2 in accordance with the present invention. FIG. 5 illustrates another non-smooth wheel 2 in accordance with the present invention. These Figures will be discussed together. An exemplary embodiment may include, for example, bumps, ridges or other contours or textures on the treating surface 6. Furthermore, embodiments of the system 1 may include wheels of any shape, size, or construction, including but not limited to those shown in FIGS. 4 and 5. The type of wheel used in a particular application may depend on a variety of factors, such as a user's or patient's desires or, as other examples, the severity, location, or most effective treatment of a particular trigger point.

Other and further embodiments utilizing one or more aspects of the inventions described above can be devised without departing from the spirit of Applicant's invention. For example, the wheels may be heated or cooled to provide desired therapies. Further, the wheels may be rotatably fixed to the axle such that the axle rotates at its ends. The various methods and embodiments of the roller system can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to fully protect all such modifications and improvements that come within the scope or range of equivalent of the following claims.

What is claimed is:

1. A roller system for treating trigger points, comprising:
an axle having a first end and a second end;
a first handle coupled to the first end of the axle;
a second handle coupled to the second end of the axle; and
at least one wheel rotatably coupled to the axle between the first and second ends and wherein the at least one wheel may be coupled at any location along the length of the axle between the first and second handles.

2. The roller system of claim 1, further comprising two or more wheels rotatably coupled to the axle.

3. The roller system of claim 1, wherein the at least one wheel is removeably coupled to the axle at a desired location using a screw.

4. The roller system of claim 1, further comprising a support bracket coupled to one or more of the handles for coupling the system to a stationary object.

5. The roller system of claim 1, wherein the at least one wheel is made of rubber.

6. A method of treating trigger points, comprising:
providing a patient having one or more trigger points;
providing a roller system having an axle and at least one wheel rotatably coupled along the axle; and
rolling the at least one wheel across a desired location on the patient's body such that the wheel manipulates one or more of the trigger points.

7. The method of claim 6, wherein the roller system has two or more wheels coupled to the axle.

8. The method of claim 6, further comprising providing a mounting bracket, coupling the roller system to the bracket, and coupling the bracket to a stationary object.
